(19) United States
(12) Patent Application Publication
(10) Pub. No.: US 2004/0204072 A1
(43) Pub. Date: Oct. 14, 2004

(54) Apparatus and method for quick control of portable phone infrared transmission

(76) Inventors: Wei Han, Changning District (CN); Shih-Kuang Tsai, Shanghai (CN); Tai-Shui Ho, Shanghai (CN)

Correspondence Address: BIRCH STEWART KOLASCH & BIRCH, PO BOX 747, FALLS CHURCH, VA, 22040-0747, US

(21) Appl. No.: 10/142,241

(22) Filed: May 10, 2002

(51) Int. Cl. H04B 1/38

(52) U.S. Cl. 455/557; 455/41.2

(57) ABSTRACT

An apparatus for quick control of portable phone infrared transmission. The apparatus includes an input module, an information process module, a data storage module, an infrared module, and a display module. The information process module couples to the input module to receive an infrared control signal, determines whether the portable phone is in standby mode, and sends an access signal, an infrared enable signal and a display signal to the data storage module, the infrared module and the display module respectively if the portable phone is in standby mode. Then, the data storage module accesses data, the infrared module receives/transmits the data and the display module displays the data or related information.

### BACKGROUND OF THE INVENTION

1. Field of the Invention

The present invention relates to an apparatus and method for quick control of portable phone infrared (IrDA) transmission, and particularly to an apparatus and method that simplifies the control process of portable phone IrDA transmissions and ensures the security of transmission.

2. Description of the Related Art

In a digitized age, everyone has large amount of information to exchange. Networks have became the major transmission media in long distance exchanges. The widespread use of Internet and telephone networks also allows personal information to be transmitted conveniently. Digital personal information, such as electric name cards and phone numbers in electronic devices, such as portable phones is just one example.

In these devices, short distance communication is generally adopted to transmit electric name cards or phone numbers. Short distance communication comprises wired and wireless transmission. Wired transmission employs a cable connected between two devices to transmit data. Wired transmission is stable and reliable. However, it is difficult to operate and compatibility is not guaranteed. Wireless transmission may transmit data via infrared rays (IrDA). By using reliable transmission protocols, the transmission of wireless transmission will be reliable and stable. The compatibility of wireless transmission can be also fully demonstrated.

Integrating the function of personal digital assistants (PDA) into portable phones the capability for data storage and data process. Further, since portable phones can exchange information via infrared rays at short distances, users can control infrared modules and related protocol to transmit electric name cards or address books.

However, there are drawbacks. The CCITT (Consultative Committee for International Telegraph and Telephone) keyboard is always used to input data or select function. Since portable phones are designed as small as possible, one key can be used to control multiple functions. The management of the input device is also complicated for portable phone systems.

Furthermore, the infrared transmission function is not as popular as other functions, such as address book function. The infrared transmission function is set up in the second level or third level submenu of the function menu. When users want to operate the infrared transmission function, users must use several keys to open the function and then return it to standby mode. The control of function selection is complicated for users.

In addition, the infrared module is power consuming. In current control practice, the infrared transmission needs a period of time to transmit or receive data. In this period, the portable phone system may receive data transmitted by other devices, and the system is dangerous if the data contains bugs or virus. More power is consumed if the period is longer.

### SUMMARY OF THE INVENTION

It is therefore an object of the present invention to provide an apparatus and method for quick control of portable phone infrared (IrDA) transmission that simplifies the control process and ensures the security of transmission, so as to operate portable phone IrDA transmission efficiently.

To achieve the above object, the present invention provides an apparatus and method for quick control of portable phone infrared transmission. According to one embodiment of the invention, an apparatus for quick control of portable phone infrared transmission includes an input module, an information process module, a data storage module, an infrared module, and a display module.

The input module is used to input an infrared control signal. The information process module couples to the input module to receive the infrared control signal, determines whether the portable phone is in standby mode in response to the infrared control signal, and sends an access signal, an infrared enable signal and a display signal if the portable phone is in standby mode.

The data storage module couples to the information process module to receive the access signal and accesses data in response to the access signal. The infrared module couples to the information process module to receive the infrared enable signal and receives/transmits the data in response to the infrared enable signal. The display module couples to the information process module to receive the display signal and displays the data in response to the display signal.

According to another embodiment of the invention, a method for quick control of portable phone infrared transmission is provided. First, an infrared control signal is input by an input module. The portable phone is assessed as being in standby mode by an information process module in response to the infrared control signal, and an infrared enable signal is sent if the portable phone is in standby mode. Then, data is received/transmitted by a infrared module in response to the infrared enable signal.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram illustrating the system components of the apparatus for quick control of portable phone infrared transmission according to the embodiment of the present invention;

FIG. 2 is a flow chart illustrating the operation of the method for quick control of portable phone infrared transmission according to the embodiment of the present invention; and

FIG. 3 illustrates a portable phone.

### DETAILED DESCRIPTION OF THE INVENTION

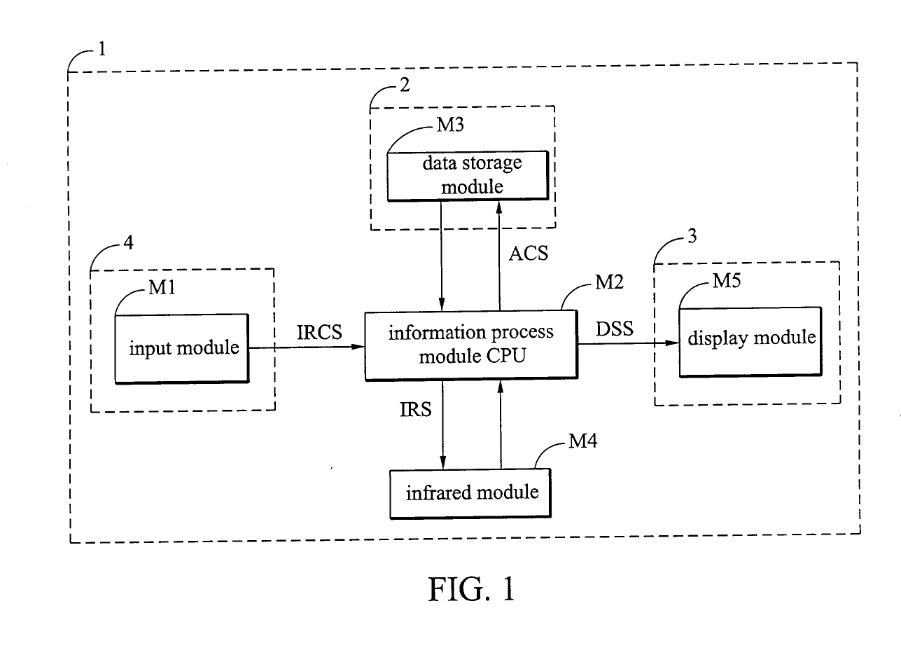

FIG. 1 shows the system components of the apparatus for quick control of portable phone infrared transmission according to the embodiment of the present invention. The apparatus includes an input module M1, an information process module M2, a data storage module M3, an infrared module M4, and a display module MS.

The input module M1 is used to input an infrared control signal IRCS. The infrared control signal may be input by users if users want to operate the infrared function. The input module M1 may be the keyboard in the portable phone. The information process module M2 may be the CPU of the portable phone. It couples to the input module M1 to receive the infrared control signal IRCS. The information process module M2 determines whether the portable phone is in standby mode in response to the infrared control signal IRCS. If the portable phone is in standby mode, the information process module M2 sends an access signal ACS, an infrared enable signal IRS and a display signal DSS.

The data storage module M3 may be composed of RAM, ROM or rewritable storage device 2, such as flash RAM. The data storage module M3 couples to the information process module M2 to receive the access signal ACS and accesses data in response to the access signal ACS. The infrared module M4 may be the infrared device. The infrared module M4 couples to the information process module M2 to receive the infrared enable signal IRS and receives or/and transmits the data in response to the infrared enable signal IRS. The display module M5 may be the LCD monitor of the portable phone. The display module MS couples to the information process module M2 to receive the display signal DSS and displays the data, related information or instructions in response to the display signal DSS.

The portable phone stays in standby mode most of the time. Users can use quick keys (hot keys) immediately without operating the menu interface in standby mode. In addition, the process of handling the input in standby mode may be simple and speedy to the portable phone system. Further, since most of the keys on the portable phone do not have particular functions in standby mode, there are more keys to set as quick keys to implement the infrared transmission function.

The portable phone can switch to the infrared transmission function immediately by operating a particular key (hot key) or a combination of keys of the input module M1 to input the infrared control signal IRCS. The particular key may be the function key, such as the menu key or the volume adjustment key. The combination of keys may be the combination of the digit keys or function keys on the keyboard.

Then, the information process module M2 analyzes and processes the input signal to determine whether it is the infrared control signal IRCS. Thereafter, the information process module M2 sends the access signal ACS, the infrared enable signal IRS and the display signal DSS to the data storage module M3, the infrared module M4 and the display module M5 respectively if the input signal is IRCS and the portable phone is in standby mode. Then, the infrared module M4 transmits the data accessed by the storage module M3 via infrared rays, and the instructions provided by the portable phone are displayed on the display module M5.

Otherwise, the portable phone operates normally if the input signal is not IRCS or the portable phone is not in standby mode. When the transmission is over, the result of the transmission is displayed on the display module M5. Finally, the portable phone system turns off the infrared system (infrared module M4).

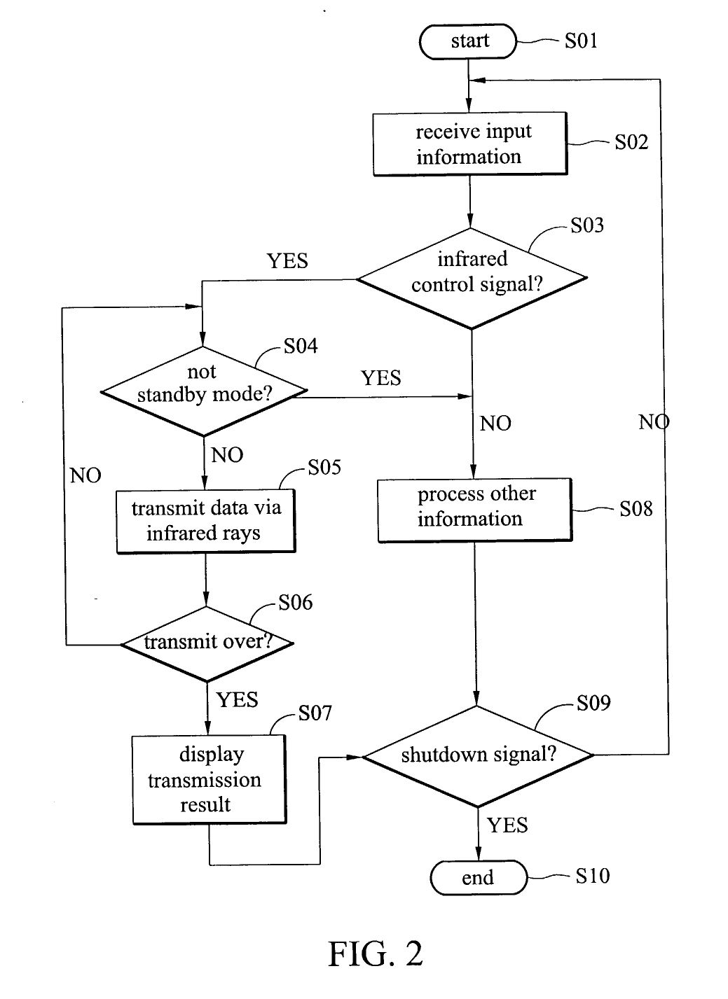

FIG. 2 shows the operation of the method for quick control of portable phone infrared transmission according to the embodiment of the present invention. After the portable phone is powered on (S01), the input information is received and analyzed (S02). Then, in step S03, the input information checked.

If the input information is not IRCS, the portable phone system processes other signals or information (S08). If the portable phone is not in standby mode, the portable phone system processes other signals or information (S08). If the portable phone is in standby mode, the infrared module is enabled to transmit or receive data (S05). Note that an interrupt module (not shown) can be used to handle users' commands and respond to users' request, such as a suspend transmission command.

The flow is returned to step S04 if the transmission is not over (NO in step S06). If the transmission is over (YES in step S06), the result of transmission is displayed (S07), and the infrared system (infrared module M4) is turned off. Finally, the portable phone is shut down if a shutdown signal is received (YES in step S09).

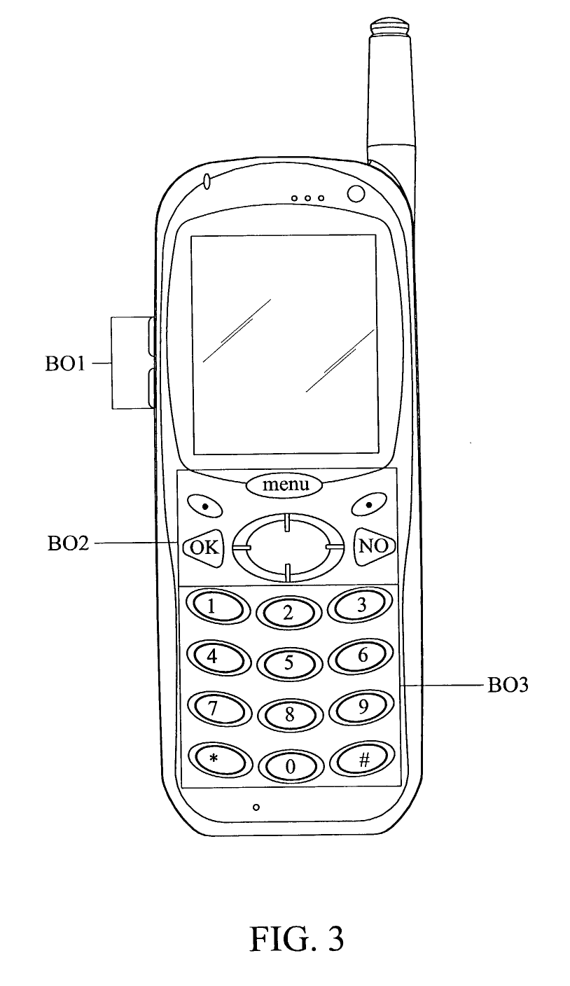

FIG. 3 illustrates a portable phone. The portable phone has function keys B02, CCITT keys B03 and volume adjustment keys B01. Since the function keys B02 and the CCITT keys B03 are used constantly and more important than the volume adjustment keys B01, the volume adjustment keys B01 may be set as the quick key to input the infrared control signal. Further, the volume adjustment keys B01 comprise a volume up key and a volume down key. The volume up key can be set as the quick key to transmit data via infrared rays, and the volume down key can be set as the quick key to receive data via infrared rays.

As a result, using the apparatus and method for quick control of portable phone infrared transmission according to the present invention, the control process of portable phone IrDA transmission can be simplified and the security of transmission can be ensured.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. An apparatus for quick control of portable phone infrared transmission, comprising:
an input module to input an infrared control signal;
an information process module coupled to the input module to receive the infrared control signal, determine whether the portable phone is in standby mode in response to the infrared control signal, and, if so, send an access signal, an infrared enable signal and a display signal;
a data storage module coupled to the information process module to receive the access signal and access data in response to the access signal;
an infrared module coupled to the information process module to receive the infrared enable signal and receive/transmit the data in response to the infrared enable signal; and
a display module coupled to the information process module to receive the display signal and display the data or related information in response to the display signal.

2. The apparatus as claimed in claim 1 wherein the information process module is the CPU of the portable phone.

3. The apparatus as claimed in claim 1 wherein the data storage module is RAM.

4. The apparatus as claimed in claim 1 wherein the data storage module is ROM.

5. The apparatus as claimed in claim 1 wherein the data storage module is flash RAM.

6. The apparatus as claimed in claim 1 wherein the display module is the LCD monitor of the portable phone.

7. The apparatus as claimed in claim 1 wherein the input module is the keyboard of the portable phone.

8. The apparatus as claimed in claim 7 wherein the keyboard comprises function keys, volume adjustment keys and CCITT keys.

9. A method for quick control of portable phone infrared transmission, comprising the steps of:
receiving an infrared control signal;
determining whether the portable phone is in standby mode in response to the infrared control signal;
sending an infrared enable signal if the portable phone is in standby mode; and
receiving/transmitting data in response to the infrared enable signal.

10. The method as claimed in claim 9 further sending an access signal to access the data from a data storage module if the portable phone is in standby mode.

11. The method as claimed in claim 9 further displaying the data or related information.

12. The method as claimed in claim 9 wherein the infrared control signal is generated by operating a combination of function keys, volume adjustment keys and CCITT keys.
